(19) United States
(12) Patent Application Publication
(10) Pub. No.: US 2012/0016766 A1
(43) Pub. Date: Jan. 19, 2012

(54) Payment System and Method for Electronic Commerce Transactions

(76) Inventors: Asheesh Raizada, West Midlands (GB); Martin Bruckner, Munchen (DE)

(21) Appl. No.: 12/838,912

(22) Filed: Jul. 19, 2010

(51) Int. Cl. G06Q 30/00; G06Q 20/00; G06K 19/06

(52) U.S. Cl. 705/26.25; 235/494; 235/375; 705/26.1

(57) ABSTRACT

A payment system and method for electronic commerce transactions is disclosed. In an exemplary embodiment, a payment administrator receives a request for a payment notice for an electronic commerce transaction, such as a purchase on a merchant website. In response, the payment administrator creates a payment notice comprising a transaction amount (which may be converted between different currencies), an age restriction for the purchased product (if applicable), and a unique identifier for the electronic commerce transaction. Preferably, the unique identifier is presented in both human-readable form and machine-readable form (such as a barcode) on the payment notice. The payment administrator then transmits the payment notice to the purchaser, who may print and take the payment notice to a retailer for full or partial payment of the transaction amount printed on the payment notice.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

1. Field of the Invention

The present invention relates generally to electronic commerce and, more particularly, to a system and method for processing payments associated with electronic commerce transactions.

2. Description of Related Art

The global increase in broadband penetration is facilitating the growth in electronic commerce. Typically, at the time a purchase is made on a merchant website, the purchaser must provide credit card information during a “checkout” phase of the transaction. By requiring the submission of credit card information as payment for the purchase, certain consumer segments are excluded from electronic commerce, such as cash-centric consumers, security conscious consumers, unbanked or under-banked consumers, migrant workers, budget conscious consumers, and the youth.

Several payment options have emerged in recent years that do not require a purchaser to provide credit card information to a merchant website. For example, one payment system displays an electronic bill at the time of checkout and/or transmits a copy of the electronic bill to the purchaser by electronic mail. The purchaser subsequently pays the electronic bill through online banking, or at a bank or other walk-in location. The purchased item is then shipped to the purchaser. Another payment system allows a purchaser to make a purchase on a merchant website whereby the purchased item is shipped to the purchaser prior to payment. A bill is mailed to the purchaser, and the purchaser may pay the bill by mail, by phone or through online banking. While these payment systems provide an alternative to the use of credit cards for online purchases, there are a number of problems that have not been addressed by these systems.

### BRIEF SUMMARY OF THE INVENTION

The present invention is directed to a payment system and method for electronic commerce transactions. In an exemplary embodiment, a purchaser accesses a merchant website to purchase a product or service and, during the checkout phase of the transaction, elects a payment option that allows the purchaser to make a payment for the purchased product or service at a later time. The purchaser is presented with a form that requires the purchaser to enter her name, address, phone number(s), e-mail address and any other information required by the merchant or payment administrator. The merchant then sends a request for a payment notice to the payment administrator. The request may include the transaction amount, the currency of the transaction, an order identifier used by the merchant, merchant information to be printed on the payment notice, the expiration date of the payment notice, any age restriction associated with the purchased product or service, or any other information that the payment administrator will need to create the payment notice.

Upon receipt of the request, the payment administrator generates a unique identifier associated with the electronic commerce transaction, and creates the payment notice with the unique identifier and other information provided by the merchant (listed above). Preferably, the unique identifier is presented in both human-readable form (such as alphanumeric characters) and machine-readable form (such as a barcode) on the payment notice. Of course, other information on the payment notice may also be presented in both human-readable form and machine-readable form, as desired. If the transaction amount received from the merchant is in a foreign currency, the payment administrator may also convert the transaction amount between currencies so that the transaction amount presented on the payment notice is in a currency used by the purchaser. The payment administrator then displays the payment notice to the purchaser at the end of the checkout process and/or transmits the payment notice to the purchaser by electronic mail. If the purchaser does not pay the transaction amount presented on the payment notice, the payment administrator may send one or more automated reminder messages notifying the purchaser of the expiration date of the payment notice. After the expiration date, the payment administrator may send an automated message to the purchaser advising that the payment notice has expired and may no longer be paid.

When the purchaser decides to pay all or a portion of the transaction amount presented on the payment notice, she may print the payment notice and proceed to a retail location for payment. The retailer reviews the payment notice and obtains the payment from the purchaser. The retailer may also be required to verify, the age of the purchaser if there are age restrictions associated with the purchased product or service (as indicated on the payment notice). The retailer then enters the unique identifier and the payment amount into a point-of-sale (POS) terminal, whereby a payment notice validation request is sent to the payment administrator. The retailer may enter the unique identifier by either (i) manual entry of the unique identifier presented in human-readable form on the payment notice or (ii) reading the unique identifier presented in machine-readable form on the payment notice (such as by using a barcode reader to read the barcode presented on the payment notice). Upon validation of the payment notice, the retailer returns the payment notice to the purchaser and issues a receipt for the transaction. The payment administrator may then send an automated message to the purchaser advising that the payment made at the retail location was successful. If the transaction amount printed on the payment notice has been paid in full, the payment administrator notifies the merchant that full payment has been made, and the merchant ships the product or provides the service to the purchaser.

### BRIEF DESCRIPTION OF THE DRAWINGS

FIG. 1 is a block diagram of an exemplary system that may be used to administer payments for electronic commerce transactions in accordance with the present invention.

FIG. 2 is an exemplary payment notice in accordance with the present invention.

FIG. 3A is a block diagram of a first business model showing the transfer of funds between a payment administrator and a “brick and mortar” merchant that also operates an e-commerce website in accordance with the present invention.

FIG. 3B is a block diagram of a second business model showing the transfer of funds between a payment administrator, a retail network and an e-commerce aggregator (who separately contracts with e-commerce merchants) in accordance with the present invention.

FIG. 3C is a block diagram of a third business model showing the transfer of funds between a payment administrator, a retail network, an e-commerce aggregator and an e-commerce merchant in accordance with the present invention.

FIG. 3D is a block diagram of a fourth business model showing the transfer of funds between a payment administrator, a retail network and an e-commerce merchant in accordance with the present invention;

FIG. 4 is a network diagram of an exemplary system that may be used to administer payments for electronic commerce transactions in accordance with the present invention.

FIG. 5 is a flow chart of an exemplary method for purchasing a product or service on a merchant's website in accordance with the present invention.

FIG. 6 is a flow chart of an exemplary method for creating a payment notice in accordance with the present invention.

FIG. 7 is a flow chart of an exemplary method for transmitting automated messages to purchasers in accordance with, the present invention.

FIG. 8 is a flow chart of an exemplary method for processing the payment of a payment notice in accordance with the present invention.

FIG. 9 is a flow chart of an exemplary method for cancelling the payment of a payment notice in accordance with the present invention

### DETAILED DESCRIPTION OF EXEMPLARY EMBODIMENTS

The present invention is directed to a payment system and method for electronic commerce transactions. While the invention will be described in detail below with reference to various exemplary embodiments, it should be understood that the invention is not limited to the specific system configuration or methodology of these embodiments. In addition, although the exemplary embodiments are described as embodying several different inventive features, one skilled in the art will appreciate that any one of these features could be implemented without the others in accordance with the invention.

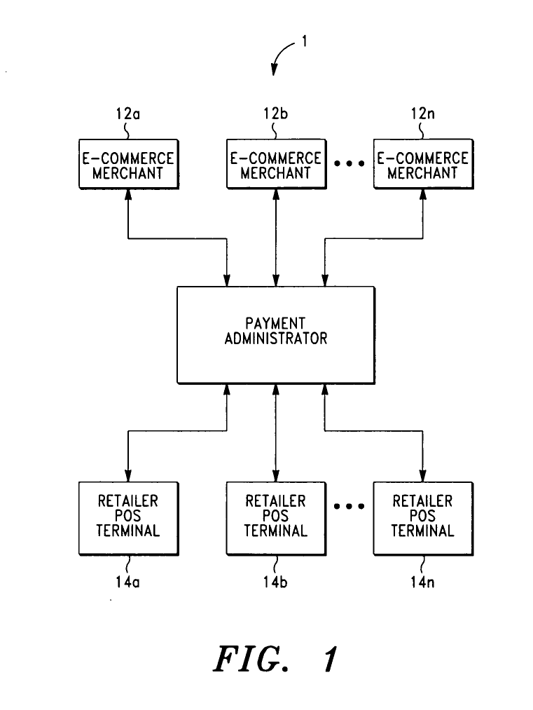

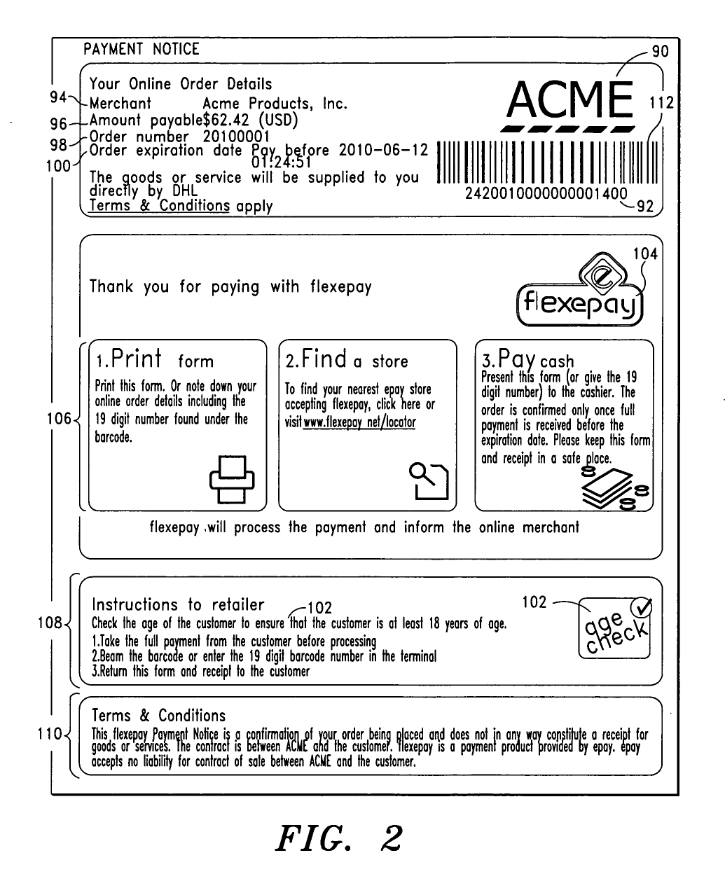

Referring to FIG. 1, a block diagram of a system that may be used to administer payments for electronic commerce transactions in accordance with the present invention is shown generally as reference numeral 1. The system includes a payment administrator 10 connected to a plurality of e-commerce merchants 12a, 12b . . . 12n. The payment administrator 10 is also connected to a retailer network, which includes a plurality of point-of-sale (POS) terminals 14a, 14b . . . 14n located at various retail locations. As will be seen, the system allows a purchaser to purchase a product or service on a merchant's website and receive a payment notice for the transaction. An exemplary payment notice is shown in FIG. 2 (described below). The purchaser may then use the payment notice to make an over-the-counter payment for the purchased product or service at a retail location, whereafter the e-commerce merchant ships the product or provides the service to the purchaser.

In general terms, the connection between the payment administrator 10 and each of the e-commerce merchants 12a, 12b . . . 12n allows the payment administrator 10 to perform the following functions: (1) the payment administrator receives a request for a payment notice from an e-commerce merchant, which includes the transaction details required to create a payment notice; (2) the payment administrator creates the payment notice and transmits the payment notice to the host server of the e-commerce merchant (whereby the payment notice is displayed to the purchaser); and (3) upon full payment of the payment notice, the payment administrator provides confirmation to the e-commerce merchant that payment has been received from the purchaser at a retailer POS terminal. Each of these functions will be described in greater detail below.

Also, the connection between the payment administrator 10 and each of the POS terminals 14a, 14b . . . 14n of the retailer network allows the payment administrator 10 to perform the following functions: (1) the payment administrator receives a payment notice validation request from a retailer POS terminal, which includes the unique identifier of the payment notice (which has been manually entered into the retailer POS terminal or scanned from a barcode printed on the payment notice) and the payment amount; (2) the payment administrator determines the transaction amount corresponding to the unique identifier and verifies that the payment amount is equal to the transaction amount (or alternatively processes a partial payment); and (3) the payment administrator sends a payment notice validation response to the retailer POS terminal. Each of these functions will also be described in greater detail below.

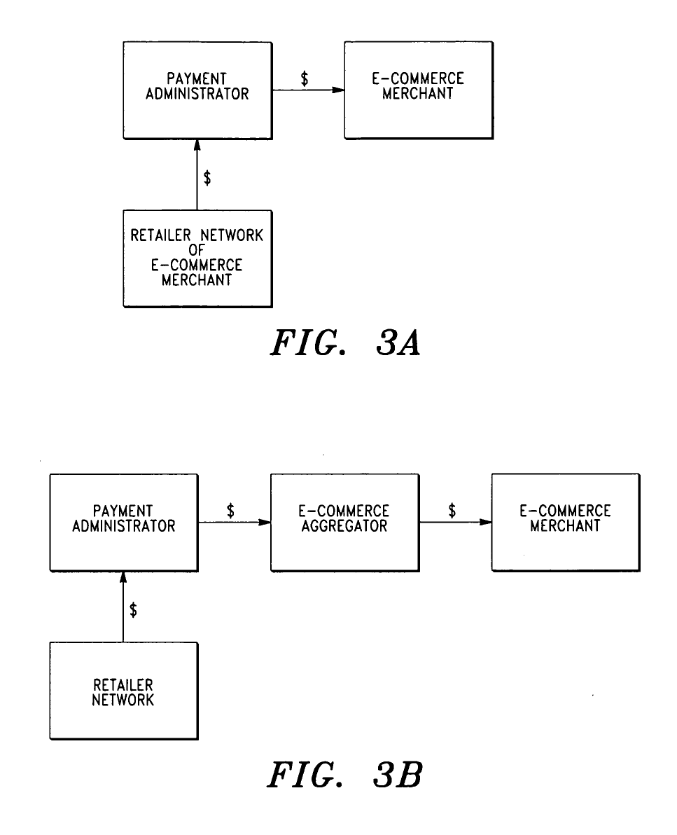

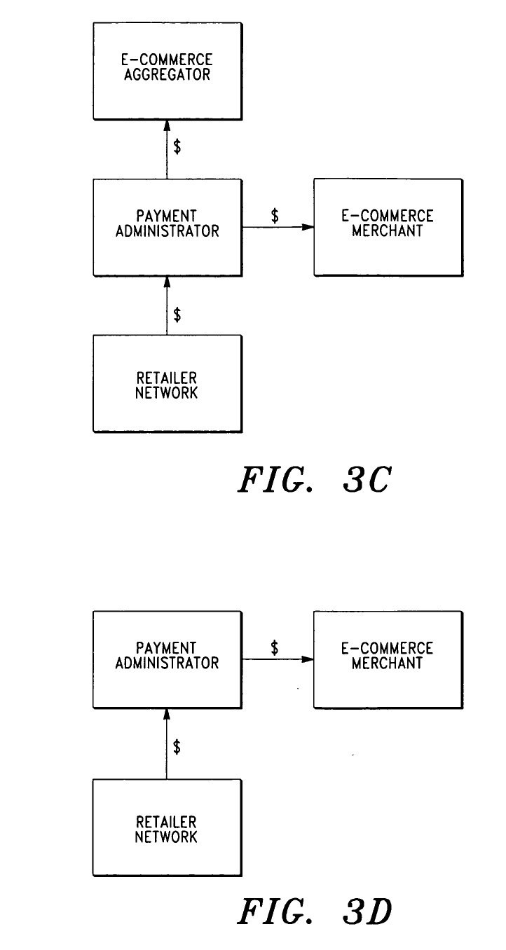

Referring to FIGS. 3A-3D, four different business models are provided showing the transfer of funds in connection with an electronic commerce transaction. In each of these business models, funds are transferred from a retailer to a payment administrator and on to an e-commerce merchant and/or an e-commerce aggregator. One skilled in the art will appreciate that these business models are merely examples of the various ways to handle the transfer of funds and that other business models could also be employed in accordance with the present invention.

FIG. 3A show a business model in which a payment administrator contracts with a “brick and mortar” merchant that operates retail locations as well as an e-commerce website. In this business model, for each transaction, the retailer charges a retailer commission RC and the payment administrator charges a transaction fee TF. Thus, if a purchaser pays the transaction amount TA presented on the payment notice to a retailer in the merchant's retailer network, the retailer would transfer funds in the amount of TA−RC to the payment administrator, who would then transfer funds in the amount of TA−RC−TF to the merchant's website. This model may be applicable, for example, in a case where each retailer in the merchant's retailer network operates as a franchise such that the retailer would be entitled to receive the retailer commission RC in connection with its processing of the payment for the payment notice. Alternatively, if the retailers in the merchant's retailer network are operated directly by the merchant (as opposed to a franchise scenario), the retailer may retain the transaction amount TA (i.e., there would be no transfer of funds to the payment administrator), in which case the merchant would pay the transaction fee TF directly to the payment administrator.

FIG. 3B shows a business model in which the payment administrator contracts with an e-commerce aggregator, such as such as a payment service provider or a payment gateway, who resells the payment service to its connected e-commerce merchants. The payment administrator has no direct relationship with the e-commerce merchants and settles funds directly with the e-commerce aggregator. The payment administrator also contracts with a retailer network that includes POS terminals located at convenient retail locations, such as corner shops, post offices, newsstands, gas stations, supermarkets and the like. The retailer network may be operated by an entity related to the payment administrator, or may be a separate and independent retailer network.

In this business model, for each transaction, the retailer charges a retailer commission RC and the payment administrator charges a transaction fee TF. Thus, if a purchaser pays the transaction amount TA presented on the payment notice to the retailer, the retailer would transfer funds in the amount of TA−RC to the payment administrator, who would then transfer funds in the amount of TA−RC−TF to the e-commerce aggregator. The e-commerce aggregator would then settle directly with the e-commerce merchant.

FIG. 3C shows a business model in which the payment administrator contracts with an e-commerce aggregator, such as such as a payment service provider or a payment gateway, who offers the payment service to its connected e-commerce merchants. Unlike the business model of FIG. 3B, the payment administrator also contracts with the e-commerce merchants with respect to the settlement of funds. The payment administrator further contracts with a retailer network, which may be operated by an entity related to the payment administrator or may be a separate and independent retailer network.

In this business model, for each transaction, the retailer charges a retailer commission RC, the payment administrator charges a transaction fee TF, and the aggregator charges an acquiring fee AF. Thus, if a purchaser pays the transaction amount TA presented on the payment notice to the retailer, the retailer would transfer funds in the amount of TA−RC to the payment administrator, who would then transfer funds in the amount of TA−RC−TF−AF to the e-commerce merchant. The payment administrator would separately transfer the acquiring fee AF to the e-commerce aggregator.

FIG. 3D shows a business model in which the payment administrator contracts with an e-commerce merchant (no e-commerce aggregator is involved). The payment administrator also contracts with a retailer network, which may be operated by an entity related to the payment administrator or may be a separate and independent retailer network. In this business model, for each transaction, the retailer charges a retailer commission RC and the payment administrator charges a transaction fee TF. Thus, if a purchaser pays the transaction amount TA presented on the payment notice to the retailer, the retailer would transfer funds in the amount of TA−RC to the payment administrator, who would then transfer funds in the amount of TA−RC−TF to the e-commerce merchant.

Optionally, in all of the business models shown in FIGS. 3A-3D, the purchaser may be required to pay a customer convenience fee CCF in addition to the transaction amount TA presented on the payment notice. This customer convenience fee CCF may be retained by the retailer (in lieu of or in addition to the retailer commission RC), may be passed on to the e-commerce merchant through the payment administrator, or may be shared between the retailer and the e-commerce merchant.

While the system and method of the present invention will be described herein as involving a payment administrator, e-commerce merchants and a retail network of POS terminals, it should be understood that an e-commerce aggregator may perform one or more of the functions described in connection with the e-commerce merchants as contemplated in FIGS. 3B and 3C above.

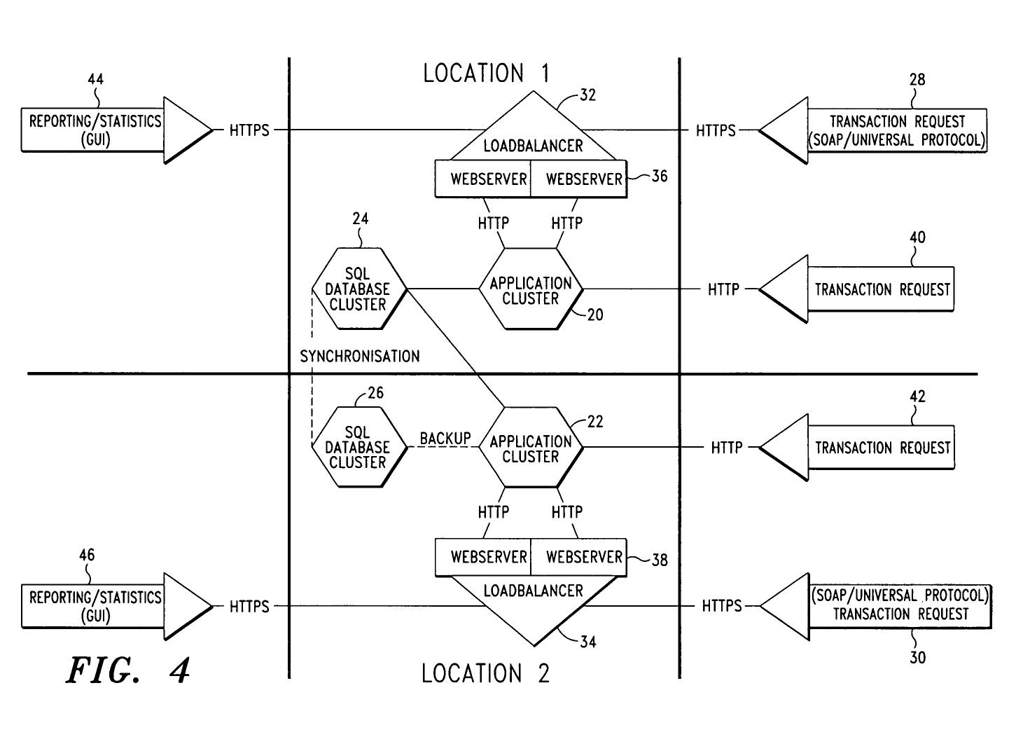

Referring to FIG. 4, a network diagram is provided showing an exemplary system that may be used by the payment administrator to process transaction requests from e-commerce merchants and retailer POS terminals in accordance with the present invention (which may be used in connection with one or all of the business models shown in FIGS. 3A-3D). As can be seen, the system hardware and software is replicated in two different geographic locations in order to provide survivability in the event of a system failure at one of the locations. Specifically, the system includes an application cluster 20, a database cluster 24, a load balancer 32 and web servers 36 located at a first location, and an application cluster 22, a database cluster 26, a load balancer 34 and web servers 38 located at a second location. As can be seen, database cluster 26 is synchronized with database cluster 24 such that each database cluster stores data relating to each transaction processed by the payment administrator, including the data contained within each payment notice and related payment information.

The e-commerce merchants and retailer POS terminals transmit transaction requests to the application clusters 20, 22 by sending either HTTPS (Hypertext Transfer Protocol Secure) messages 28, 30 or HTTP (Hypertext Transfer Protocol) messages 40, 42. As discussed below, the transaction requests originating from the e-commerce merchants comprise payment notice requests (i.e., requests for the creation of payment notices), and the transactions requests originating from the retailer POS terminals comprise either payment notice validation requests (i.e., requests to accept/validate a full or partial payment of a payment notice) or cancellation requests (i.e., requests to cancel a full or partial payment of a payment notice).

The HTTPS messages 28, 30 are routed to load balancers 32, 34, whereby web servers 36, 38 decrypt the HTTPS messages before being transmitted to application clusters 20, 22. Each HTTPS message preferably includes the username and password of the e-commerce merchant or retailer POS terminal, and may optionally include a terminal ID. As an example, if an e-commerce merchant uses different webshops to sell its product or service and desires to obtain a separate report for each webshop (as discussed below), the HTTPS message may include the username and password of the e-commerce merchant and the terminal ID of the webshop.

The HTTP messages 40, 42 are routed directly to application clusters 20, 22 (i.e., decryption is not required). One skilled in the art will understand that the HTTP messages may be received from a terminal concentrator operated by a terminal network provider, which is in turn connected to a plurality of terminals. The terminal concentrator functions to change the format of the message from the format used by the terminal (e.g., an APACS or ISO8583 based protocol) to the HTTP format prior to transmission to application clusters 20, 22. In this case, each HTTP message includes the username and password of the terminal concentrator, as well as the terminal ID of the originating terminal.

Preferably, the e-commerce merchants communicate with the application clusters 20, 22 through Web Services. As is known in the art, Web Services is an API (Application Programming Interface) that allows a user to access and execute code that resides on a remote system. Web Services uses XML (eXtensible Markup Language) messages that follow the SOAP (Simple Object Access Protocol) standard on an encrypted transport layer, such as HTTP over a virtual private network (VPN) or HTTPS. In this case, Web Services allows the payment applications used by the e-commerce merchants to remotely call modules of code that reside on application clusters 20, 22. As such, the e-commerce merchants are able to integrate the payment option offered by the payment administrator quickly, easily and inexpensively with reduced software development and maintenance times.

Referring still to FIG. 4, the application clusters 20, 22 also include a graphical user interface (GUI) that enables each e-commerce merchant to review reports and statistics on the transactions processed by the payment administrator on behalf of that e-commerce merchant. The requests for such reports and statistics comprise HTTPS messages 44, 46 that are routed to load balancers 32, 34, whereby web servers, 36, 38 decrypt the HTTPS messages before being transmitted to application clusters 20, 22. The reports and statistics may include configuration information, status changes of the payment notices (e.g., open payment notices, paid payment notices, expired payment notices, etc.), and other information relating to the transactions processed by the payment administrator. As discussed above, if an e-commerce merchant uses different webshops to sell its product or service, separate reports and statistics may be provided for each webshop.

Of course, one skilled in the art will understand that the system shown in FIG. 4 is merely an example of a system that may be used by a payment administrator and that other systems could also be employed in accordance with the present invention. For example, while the system shown in FIG. 4 includes application clusters and database clusters, one skilled in the art will understand that other types of server configurations may be employed in accordance with the present invention. Also, while the transaction requests have been described as including usernames, passwords and/or terminal IDs to identify the e-commerce merchants or retailer POS terminals, one skilled in the art will understand that the information contained in the transaction requests may vary in accordance with the system configuration.

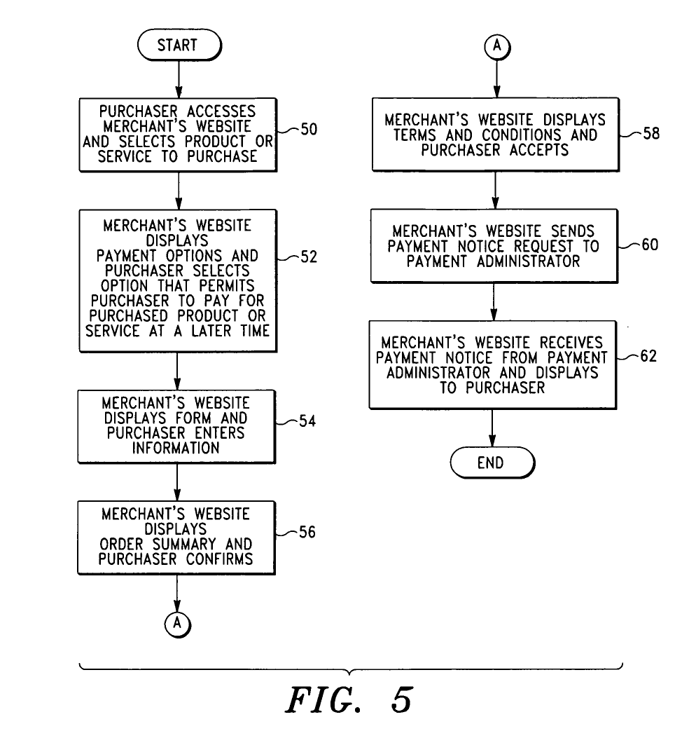

Referring to FIG. 5, a flow chart of an exemplary method for purchasing a product or service on a merchant's website in accordance with the present invention will be described with reference to steps 50 to 62. First, in step 50, a purchaser accesses a merchant's website to purchase a selected product or service. A typical retail purchase requires the purchaser to select the option “Go to Checkout” or “Shopping Cart” to complete the purchase of the product. At this time, the website displays a summary that includes a description of the purchased product and its associates price, any applicable taxes or shipping/handling charges, and the total of the foregoing charges. Alternatively, the website may allow the purchaser to specify a payment amount. This may apply in connection with the purchase of certain pre-paid services, such as utilities, where a purchaser is able to fund an account.

In step 52, the merchant's website displays various payment options, such as credit card, debit card, or the payment option provided by the present invention. In this case, the purchaser selects the payment option provided by the present invention, which permits the purchaser to pay for the purchased product or service at a later time. In step 54, the website displays a form that requires the purchaser to fill-in various fields of information required by the merchant for fulfillment of the order or by the payment administrator for creation of the payment notice. Typical fields of information include name, address, home phone number, mobile phone number (needed for SMS (Short Message Service) delivery), and e-mail address. The purchaser completes the form by entering the required information. In step 56, the website displays an order summary and the purchaser confirms the accuracy of the information.

In step 58, the merchant's website displays the applicable terms and conditions of the transaction. Upon acceptance of the terms and conditions, in step 60, the e-commerce merchant transmits a payment notice request to the payment administrator, who creates a payment notice for the transaction (described in greater detail below). In step 62, the merchant's website receives the payment notice from the payment administrator and displays the payment notice in a printable format, whereby the purchaser may print the payment notice if desired. Preferably, the website displays a store locator link (which provides access to a list of retail locations at which the payment notice can be paid) and/or an information link (which provides access to detailed information on the “pay later” payment option) throughout the check-out process.

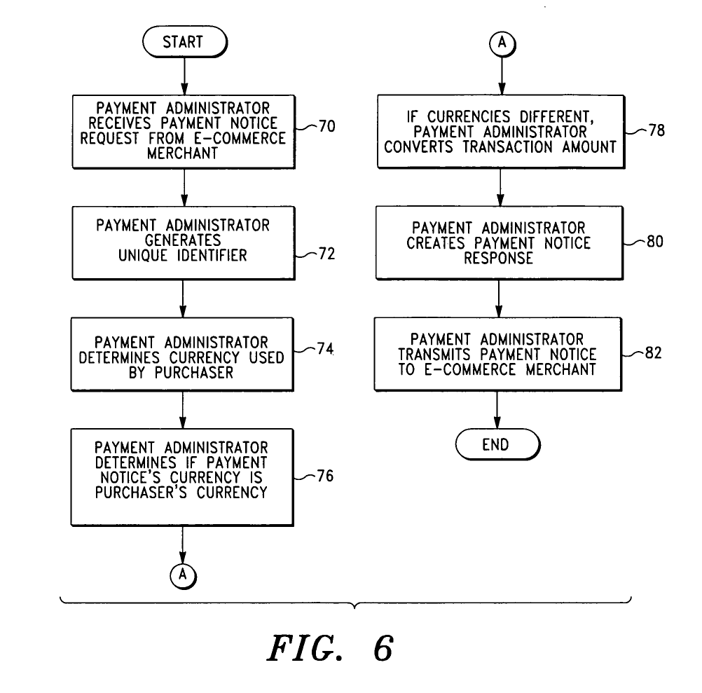

Referring to FIG. 6, a flow chart of an exemplary method for creating a payment notice in accordance with the present invention will be described with reference to steps 70 to 82. First, in step 70, the payment administrator receives a payment notice request from an e-commerce merchant in connection with a particular e-commerce transaction. The payment notice request includes data fields that the payment administrator will use to create the payment notice. These data fields are listed in the table below by identifying the “Name” of the data field, the “Type” of the data field (i.e., string of alphanumeric characters, decimal, date and time in coordinated universal time (UTC)), and a “Description” of the data field:

| Name | Type | Description |
|---|---|---|
| TermDateTime | DateTime | This is the local date and time of the merchant's terminal. |
| TxId | String | This is a unique ID assigned by the merchant's terminal. |
| Amount | Decimal | This is the amount of the transaction (e.g., price of the |
| | | purchased product, plus any applicable taxes and |
| | | shipping/handling charges). |
| Currency | String | This is the currency of the transaction as specified in ISO-4217 |
| | | (e.g., EUR, USD, etc.). |
| OrderId | String | This is the ID of the order assigned by the merchant. This ID is |
| | | optional and is not used by the payment administrator, but can |
| | | be included on the payment notice for reference purposes. |
| CustomerInfo | String | This is the customer information to be printed on the payment |
| | | notice, including the merchant's name and shipping information. |
| ValidUntil | DateTime | This is the date and time until which the payment notice can be |
| | | paid. |
| ExtendedXml | String | This is an XML string that is used to pass additional information |
| | | from the merchant to the payment administrator. |

The ExtendedXml data field may include various types of information. For example, the data field may include information indicating whether the merchant allows partial payments whereby the payment notice is paid in multiple payment transactions. In this case, the data field may indicate “0” if partial payments are not allowed (which is the default) or “1” if partial payments are allowed. As another example, the data field may include information indicating whether there is an age restriction associated with the purchased product. In this case, the data field may indicate “0” if there is no age restriction (which is the default) or an age stipulated by the merchant (e.g., 12, 15, 16, 18 or 21) if there is an age restriction. Examples of age restricted products include alcohol, cigarettes and tobacco, fireworks, movies, video and computer games, and lottery tickets, although other types of products may also be age restricted as is known in the art.

As another example, the ExtendedXml data field may include information indicating whether the purchaser is required to pay a customer convenience fee (discussed in connection with FIGS. 3A-3D above). In this case, the data field may indicate “0” if there is no customer convenience fee (which is the default) or an amount stipulated by the merchant if there is a customer convenience fee. As a further example, the data field may include information indicating the date and time from which the payment notice can be paid. In this case, the data field may indicate the date and time that the invoice was created (which is the default) or a subsequent date and time stipulated by the merchant.

Of course, one skilled in the art will appreciate that the ExtendedXml data field may contain any type of information that the merchant wishes to pass to the payment administrator, and is not limited to the examples provided above. For example, the ExtendedXml data field may contain the purchaser's residence address, the purchaser's e-mail address, or any other additional information required by the payment administrator.

In step 72, upon receipt of the payment notice request, the payment administrator generates a unique identifier associated with the e-commerce transaction. In the exemplary embodiment, the unique identifier comprises a 19 digit number. Of course, the unique identifier may comprise any string of alphanumeric characters or other types of identifiers as are known in the art.

In step 74, the payment administrator determines the currency used by the purchaser (which will be the currency used by the retailer accepting payment for the payment notice). For example, if the purchaser has an address in the United States, the currency is USD. In step 76, the payment administrator determines if the currency provided in the payment notice request is the same as the currency used by the purchaser. For example, if a purchaser having an address in the United States purchases a product on a website operated in the United Kingdom, the currency provided in the payment notice request will be EUR and the currency used by the purchaser will be USD.

In step 78, if the currencies are different, the payment administrator converts the transaction amount from the currency provided in the payment notice request to the currency used by the purchaser using the applicable exchange rate (e.g., convert the transaction amount from EUR to USD). The payment notice presents the transaction amount in the currency of the purchaser (e.g., USD). Of course, the payment notice may also present the exchange rate used in the conversion and/or the transaction amount and currency provided in the payment notice request for informational purposes only (i.e., the payment notice should clearly indicate that the converted transaction amount must be paid by the purchaser). Thus, the system allows retailers in multiple countries to accept payments for e-commerce transactions irrespective of the location of the e-commerce merchant. As such, retailers can accept payments for “cross border” e-commerce transactions.

In step 80, the payment administrator creates a payment notice response for the e-commerce transaction (which may be stored, for example, in the database clusters 24, 26, 28, 30 shown in FIG. 4). The data fields contained in the payment notice response are listed in the table below by identifying the “Name” of the data field, the “Type” of the data field (i.e., string of alphanumeric characters, decimal, integer, date and time in UTC), and a “Description” of the data field (wherein the data fields indicated with an asterisk (*) contain data provided in the payment notice request, described above):

| Name | Type | Description |
|---|---|---|
| ServerDateTime | DateTime | This is the local date and time of the payment |
| | | administrator's server. |
| HoxtTxId | String | This is a unique ID of the transaction assigned by the |
| | | payment administrator's server. |
| Id | String | This is the unique identifier of the payment notice |
| | | generated by the payment administrator (determined in step |
| | | 72 above). |
| Created | DateTime | This is the date and time when the payment notice was |
| | | created. |
| ValidUntil* | DateTime | This is the date and time until which the payment notice |
| | | can be paid. |
| StatusCode | Integer | This is the status of the payment notice as a numeric value |
| | | (described below). |
| StatusText | String | This is the status of the payment notice as text (described |
| | | below). |
| Amount | Decimal | This is the transaction amount of the payment notice |
| | | (determined in step 78 above). |
| Currency | String | This is the currency of the payment notice as specified in |
| | | ISO-4217 (e.g., EUR, USD, etc.) (determined in step 74 |
| | | above). |
| CustomerInfo* | String | This is the customer information to be printed on the |
| | | payment notice, including the merchant's name and |
| | | shipping information. |
| OrderID* | String | This is the ID of the order assigned by the merchant. This |
| | | ID is optional and is not used by the payment administrator, |
| | | but can be included on the payment notice for reference |
| | | purposes. |
| ExtendedXml* | String | This is an XML, string with additional options (described above). |

In the exemplary embodiment, it should be noted that the expiration date of the payment notice is sent from the e-commerce merchant to the payment administrator in the ValidUntil data field. Alternatively, the payment administrator may calculate the expiration date based on the creation date of the payment notice and a specified period of time (e.g., 1 month). For example, the payment administrator may set a default period of time, or may use a period of time provided by the e-commerce merchant. As such, all payment notices will expire at the end of that specified period of time.

The StatusCode and StatusText data fields contain the status of the payment notice as a numeric value and as text, respectively, as indicated in the table below:

| StatusCode | StatusText | Description |
|---|---|---|
| −1 | NOTEXISTS | The payment notice does not exist. |
| 0 | NOTPAID | The payment notice has not been paid. |
| 1 | PAID | The payment notice has been paid. |
| 2 | PARTIALLYPAID | The payment notice has been partially paid. |
| 3 | EXPIRED | The payment notice has expired without being paid. |
| 4 | NOTVALID | The payment notice is not valid yet and cannot be paid. |
| 5 | DEACTIVATED | The payment notice has been deactivated and cannot be |
| | | paid. |

Of course, at the time that the payment administrator creates the payment notice response, the StatusCode and StatusText data fields will be 0 and NOTPAID, respectively, indicating that the payment notice exists but has not yet been paid. One skilled in the art will understand that the StatusCode and StatusText data fields are dynamic and may be used to indicate the status of a payment notice at any time.

In step 82, the payment administrator transmits the payment notice to the e-commerce merchant for display to the purchaser in a printable format (discussed above). The payment administrator may also send a secondary copy of the payment notice to the purchaser via e-mail (e.g., as a .pdf attachment). In addition, the payment administrator may send a text message via SMS (Short Message Service) to the purchaser advising her that the payment notice has been sent by e-mail.

An exemplary payment notice is shown in FIG. 2. As can be seen, the payment notice includes information contained in the payment notice response, including: the logo of the e-commerce merchant 90 (which may be provided via a link to the graphic); the unique identifier for the payment notice 92 (contained in the Id data field); the legal name of the e-commerce merchant 94 (contained in the CustomerInfo data field); the transaction amount payable for the purchased product or service 96 (contained in the Amount data field); the merchant's order number 98 (contained in the OrderID data field); the expiration date of the payment notice 100 (contained in the ValidUntil data field); and an “age check” logo and message indicating that the retailer should verify that the age of the purchaser satisfies the age restriction stipulated by the merchant 102 (contained in the ExtendedXml data field).

The payment notice also includes fixed information that is the same on every payment notice, including: the logo of the payment administrator 104; purchaser instructions 106 (describing how the purchaser can pay the payment notice at a retail location, including a link to a retail store locator that allows the purchaser to find the nearest retailer where she can make a payment); retailer instructions 108 (describing what the cashier must do in order to accept and process a payment for the payment notice), and any applicable terms and conditions 110.

The payment notice also includes a barcode 112 that encodes all or a portion of the information presented on the payment notice, including the unique identifier for the payment notice 92. As such, the unique identifier is provided in both a machine-readable form (i.e., encoded in the barcode) and in a human-readable form (i.e., the unique identifier 92 located below the barcode). As described below, a retailer will have the option of entering the unique identifier into a POS terminal by either manual entry of the unique identifier 92 or scanning the barcode 112 with a conventional barcode reader. The barcode 112 may also encode the transaction amount payable for the purchased product or service such that a retailer will also have the option of entering this information via manual entry of transaction amount 96 or scanning the barcode 112 with a conventional barcode reader. In addition, the barcode 112 may encode an age verification flag that will prompt the retailer to verify that the age of the purchaser satisfies the age restriction stipulated by the merchant. One skilled in the art will understand that other types of information may also be encoded in the barcode 112 in accordance with the present invention.

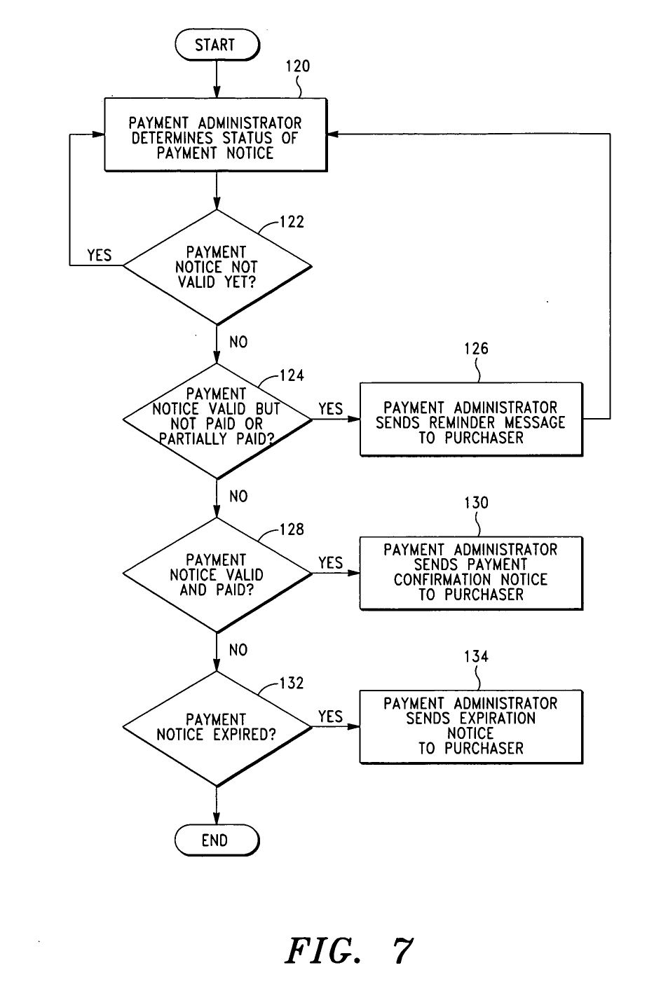

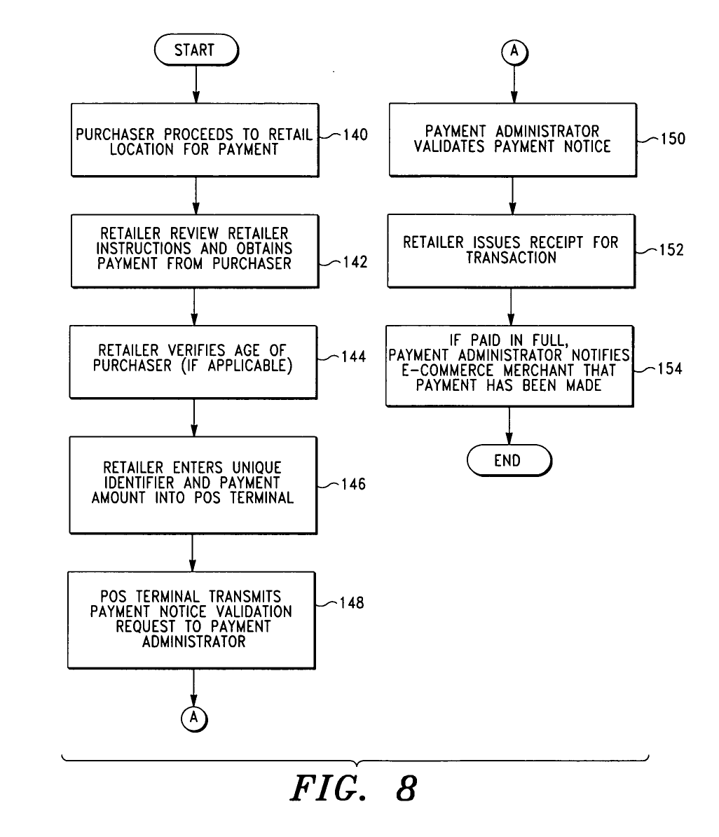

Referring to FIG. 7, a flow chart of an exemplary method for transmitting automated messages to a purchaser in relation to a payment notice in accordance with the present invention will be described with reference to blocks 120 to 134. In step 120, the payment administrator determines the current status of the payment notice. In step 122, the payment administrator determines if the payment notice is not valid yet. If so, the payment administrator continues to monitor the status of the payment notice until the date on which the payment notice becomes valid. If the payment notice is valid, in step 124, the payment administrator determines if the payment notice has not been paid or has only been partially paid (but has not yet expired). In either case, in step 126, the payment administrator transmits one or more automated reminder messages to the purchaser notifying her of the expiration date of the payment notice. The frequency of such reminder messages may be determined by the e-commerce merchant, may be a general configuration in the system set-up, or may be provided as an additional parameter in the payment notice request. In step 128, the payment administrator determines if the payment notice has been paid. If so, in step 130, the payment administrator transmits an automated message to the purchaser notifying her that the payment has been confirmed. In step 132, the payment administrator determines if the payment notice has expired without being paid or has been deactivated. If so, in step 134, the payment administrator transmits an automated message to the purchaser notifying her that the payment notice has expired and can no longer be paid.

The automated messages transmitted from the payment administrator to the purchaser in steps 126, 130 and 134 (described above) may comprise a voice message, a text message, an e-mail, an instant message, or a combination of any of the foregoing (or any other type of textual or audio alert). Alternatively, the payment administrator may provide information to the e-commerce merchant that would allow the e-commerce merchant to send the messages directly to the purchaser.

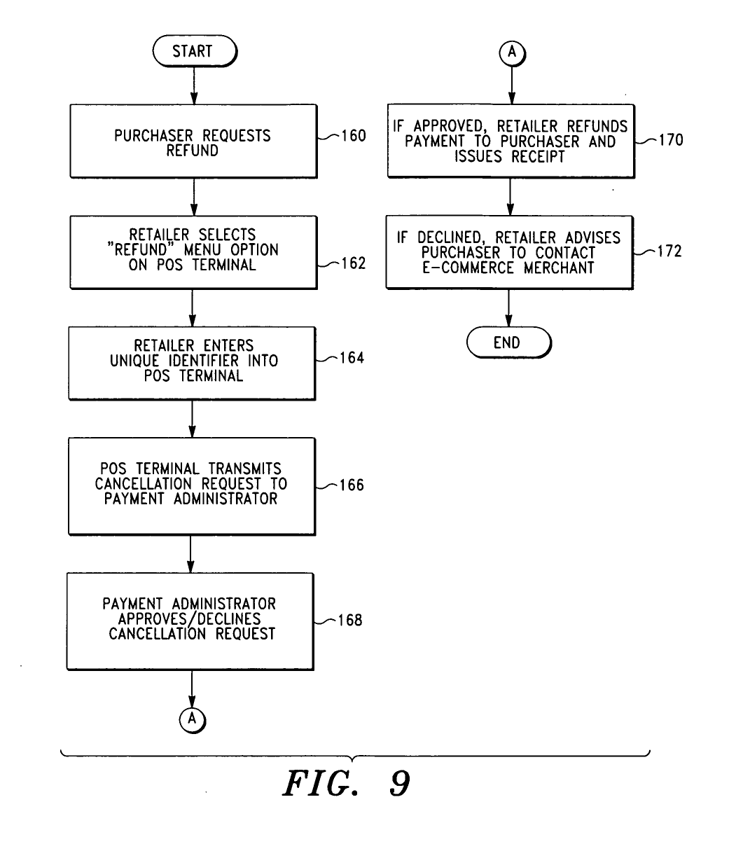

Referring to FIG. 8, a flow chart of an exemplary method for processing the payment of a payment notice in accordance with the present invention will be described with reference to steps 140 to 154. In step 140, when a purchaser decides to pay the transaction amount presented on the payment notice (or make a partial payment of such transaction amount), she may print the payment notice and proceed to a retail location for payment. In step 142, the retailer reviews the retailer instructions presented on the payment notice (e.g., retailer instructions 108 in FIG. 2) and obtains the payment from the purchaser. In step 144, if there is an age restriction associated with the purchased product, the retailer reviews the age restriction message on the payment notice (e.g., message 102 in FIG. 2) and verifies the age of the purchaser. For example, the retailer may review the purchaser's driver's license to ensure that the purchaser's age meets the age presented on the payment notice.

In step 146, the retailer enters the unique identifier and the payment amount into the retailer's POS terminal. The retailer may enter the unique identifier by either (i) manual entry of the unique identifier presented in human-readable form on the payment notice (e.g. unique identifier 92 in FIG. 2) or (ii) reading the unique identifier presented in machine-readable form on the payment notice, such as by using a barcode reader to read the barcode presented on the payment notice (e.g., barcode 112 in FIG. 2). It can be appreciated that providing the barcode option to the retailer will enable the retailer to process the payment quickly, efficiently and accurately (i.e., there is no need to manually enter a multi-digit number into the POS terminal, which is prone to human error and may result in processing errors). The retailer may also enter the payment amount by manual entry, or alternatively, by reading the barcode presented on the payment notice (in cases where the transaction amount is encoded in the barcode). Of course, if the purchaser has not printed the payment notice, she may verbally convey the unique identifier and payment amount to the retailer, in which case the retailer will have to manually enter the information into the POS terminal.

In step 148, the retailer POS terminal transmits a payment notice validation request to the payment administrator in order to validate the payment notice. The data fields contained in the payment notice validation request are listed in the table below by identifying the “Name” of the data field, the “Type” of the data field (i.e., string of alphanumeric characters, decimal, date and time in UTC), and a “Description” of the data field:

| Name | Type | Description |
|---|---|---|
| TermDateTime | DateTime | This is the local date and time of the retailer POS terminal. |
| TxId | String | This is a unique ID assigned by the retailer POS terminal. |
| InvoiceId | String | This is the unique identifier of the payment notice. |
| Amount | Decimal | This is the amount being paid by the purchaser. |
| Currency | String | This is the currency of the payment notice as specified in ISO- |
| | | 4217 (e.g., EUR, US, etc.). |
| ExtendedXml | String | This is an XML string with additional options (described above). |

In step 150, the payment administrator validates the payment notice and sends a payment notice validation response to the retailer POS terminal. In order to validate the payment notice, the payment administrator may access the payment notice data corresponding to the unique identifier and verify that the payment notice has not been fully paid and has not expired. Optionally, if there is an age restriction associated with the purchased product, the payment administrator may transmit a prompt to the retailer POS terminal, which informs the retailer that he is required to undertake an age verification check on the purchaser (which may have already been done in connection with step 144 above).

In step 152, upon validation of the payment notice, the retailer returns the payment notice to the purchaser and issues a receipt for the transaction. Optionally, the payment administrator may send an e-mail to the purchaser confirming that payment for the product or service has been received (as discussed above in connection with FIG. 7). In step 154, if the payment notice has been paid in full, the payment administrator notifies the merchant that full payment has been made, and the merchant ships the product or provides the service to the purchaser.

Referring to FIG. 9, a flow chart of an exemplary method for cancelling the payment of a payment notice in accordance with the present invention will be described with reference to steps 160 to 172. In step 160, the purchaser informs the retailer that she has changed her mind and requests a refund of the payment amount. In step 162, the retailer selects “refund” from the menu options on the POS terminal. In step 164, the retailer is prompted to enter the unique identifier and the ID of the transaction to be cancelled. In step 166, upon entry of this information, the POS terminal transmits a cancellation request to the payment administrator. The data fields contained in the cancellation request are listed in the table below by identifying the “Name” of the data field, the “Type” of the data field (i.e., string of alphanumeric characters, date and time in UTC), and a “Description” of the data field:

| Name | Type | Description |
|---|---|---|
| TermDateTime | DateTime | This is the local date and time of the retailer |
| | | POS terminal. |
| TxId | String | This is a unique ID assigned by the retailer |
| | | POS terminal. |
| OriginalTxRef | String | This is the ID of the transaction to be |
| | | cancelled. |
| InvoiceId | String | This is the unique identifier of the payment |
| | | notice that was being paid in the referenced |
| | | transaction. |

In step 168, the payment administrator approves or declines the cancellation request. For example, the cancellation request may be approved if made within a specified period of time (e.g., within a ten minute window), and declined if made outside of this window. Alternatively, the payment administrator may pass the cancellation request to the e-commerce merchant, who would then approve or decline as dictated by rules defined by the e-commerce merchant.

In step 170, if the cancellation request is approved, the POS terminal authorizes the refund and produces a receipt detailing that the transaction has been cancelled. Preferably, two copies of the receipt are produced—a copy for the retailer and a copy for the purchaser. The retailer then refunds the payment amount to the purchaser. In step 172, if the cancellation request is declined, the retailer may advise the purchaser to contact the e-commerce merchant directly as the POS terminal will not authorize the refund.

As an alternative to the methods described in steps 140-172, the retailer may validate the payment notice with the payment administrator prior to obtaining payment from the purchaser. In this case, it is possible that the purchaser may not hand over the payment to the retailer until after the payment notice has been validated with the payment administrator. In such event, the retailer may cancel the transaction before the payment administrator notifies the merchant that payment has been made.

While the present invention has been described and illustrated hereinabove with reference to various exemplary embodiments, it should be understood that various modifications could be made to these embodiments without departing from the scope of the invention. In addition, it should be understood that these exemplary embodiments embody different inventive features. One skilled in the art will appreciate that any one of these inventive features could be implemented without the others. Therefore, the present invention is not to be limited to the specific configurations or methodology of the exemplary embodiments, except insofar as such limitations are included in the following claims.

What is claimed and desired to be secured by Letters Patent is as follows:

1. A system for creating a payment notice associated with an electronic commerce transaction, comprising:
an application server operable to: (1) receive a payment notice request comprising a transaction amount for the electronic commerce transaction; (2) generate a unique identifier for the electronic commerce transaction; and (3) create a payment notice comprising the unique identifier and the transaction amount for the electronic commerce transaction, wherein the unique identifier is presented in both a human-readable form and a machine-readable form on the payment notice; and
a database server operable to store the transaction amount in relation to the unique identifier for the electronic commerce transaction.

2. The system of claim 1, wherein the unique identifier is presented in machine-readable form by encoding the unique identifier in a barcode.

3. The system of claim 1, wherein the payment notice request is received from a requester selected from the following group: an electronic commerce merchant and an electronic commerce aggregator.

4. The system of claim 3, wherein the application server is operable to transmit the payment notice to the requester.

5. The system of claim 3, wherein the application server is operable to transmit the payment notice to a purchaser associated with the electronic commerce transaction.

6. The system of claim 1, wherein the application server is operable to receive a payment notice validation request from a retailer.

7. The system of claim 6, wherein the payment notice validation request is initiated by either (i) manual entry of the unique identifier presented in human-readable form on the payment notice or (ii) reading the unique identifier presented in machine-readable form on the payment notice.

8. The system of claim 7, wherein the unique identifier is presented in machine-readable form by encoding the unique identifier in a barcode, and wherein the retailer utilizes a barcode reader operable to read the barcode presented on the payment notice.

9. The system of claim 1, wherein the payment notice is printable so as to allow reading of the unique identifier presented in machine-readable form.

10. A computer-implemented method for creating a payment notice associated with an electronic commerce transaction, comprising:
receiving a payment notice request comprising a transaction amount for the electronic commerce transaction;
generating a unique identifier for the electronic commerce transaction;
creating a payment notice comprising the unique identifier and the transaction amount for the electronic commerce transaction, wherein the unique identifier is presented in both a human-readable form and a machine-readable form on the payment notice; and
storing the transaction amount in relation to the unique identifier for the electronic commerce transaction.

11. The computer-implemented method of claim 10, further comprising encoding the unique identifier in a barcode to thereby present the unique identifier in machine-readable form on the payment notice.

12. The computer-implemented method of claim 10, wherein the payment notice request is received from a requester selected from the following group: an electronic commerce merchant and an electronic commerce aggregator.

13. The computer-implemented method of claim 12, further comprising transmitting the payment notice to the requester.

14. The computer-implemented method of claim 12, further comprising transmitting the payment notice to a purchaser associated with the electronic commerce transaction.

15. The computer-implemented method of claim 10, further comprising receiving a payment notice validation request from a retailer.

16. The computer-implemented method of claim 15, wherein the payment notice validation request is initiated by either (i) manual entry of the unique identifier presented in human-readable form on the payment notice or (ii) reading the unique identifier presented in machine-readable form on the payment notice.

17. The computer-implemented method of claim 16, further comprising encoding the unique identifier in a barcode to thereby present the unique identifier in machine-readable form on the payment notice, and wherein the retailer utilizes a barcode reader operable to read the barcode presented on the payment notice.

18. The computer-implemented method of claim 1, wherein the payment notice is printable so as to allow reading of the unique identifier presented in machine; readable form.

19. A system for creating a payment notice associated with an electronic commerce transaction, comprising:
an application server operable to: (1) receive a payment notice request comprising a transaction amount and an age restriction for the electronic commerce transaction; (2) generate a unique identifier for the electronic commerce transaction; and (3) create a payment notice comprising the unique identifier, the transaction amount and the age restriction for the electronic commerce transaction; and
a database server operable to store the transaction amount and the age restriction in relation to the unique identifier for the electronic commerce transaction.

20. The system of claim 19, wherein the age restriction is associated with a purchase of an age restricted product.

21. The system of claim 19, wherein the payment notice comprises a textual message indicating that a purchaser's age must meet the age restriction.

22. The system of claim 19, wherein the payment notice request is received from a requester selected from the following group: an electronic commerce merchant and an electronic commerce aggregator.

23. The system of claim 22, wherein the application server is operable to transmit the payment notice to the requester.

24. The system of claim 22, wherein the application server is operable to transmit the payment notice to a purchaser associated with the electronic commerce transaction.

25. The system of claim 19, wherein the application server is operable to receive a payment notice validation request from a retailer.

26. The system of claim 25, wherein the payment notice validation request comprises the unique identifier presented on the payment notice.

27. The system of claim 26, wherein the application server is operable to transmit the age restriction associated with the unique identifier to the retailer for verification of a purchaser's age.

28. The system of claim 19, wherein the payment notice is printable so as to allow a retailer to review the age restriction for the electronic commerce transaction.

29. A computer-implemented method for creating a payment notice associated with an electronic commerce transaction, comprising:
receiving a payment notice request comprising a transaction amount and an age restriction for the electronic commerce transaction;
generating a unique identifier for the electronic commerce transaction;
creating a payment notice comprising the unique identifier, the transaction amount and the age restriction for the electronic commerce transaction; and
storing the transaction amount and the age restriction in relation to the unique identifier for the electronic commerce transaction.

30. The computer-implemented method of claim 29, wherein the age restriction is associated with a purchase of an age restricted product.

31. The computer-implemented method of claim 29, wherein the payment notice comprises a textual message indicating that a purchaser's age must meet the age restriction.

32. The computer-implemented method of claim 29, wherein the payment notice request is received from a requester selected from the following group: an electronic commerce merchant and an electronic commerce aggregator.

33. The computer-implemented method of claim 32, further comprising transmitting the payment notice to the requester.

34. The computer-implemented method of claim 32, further comprising transmitting the payment notice to a purchaser associated with the electronic commerce transaction.

35. The computer-implemented method of claim 29, further comprising receiving a payment notice validation request from a retailer.

36. The computer-implemented method of claim 35, wherein the payment notice validation request comprises the unique identifier presented on the payment notice.

37. The computer-implemented method of claim 36, further comprising transmitting the age restriction associated with the unique identifier to the retailer for verification of a purchaser's age.

38. The computer-implemented method of claim 29, wherein the payment notice is printable so as to allow a retailer to review the age restriction for the electronic commerce transaction.

39. A system for notifying a purchaser of an unpaid payment notice associated with an electronic commerce transaction, comprising:
an application server operable to: (1) receive a payment notice request comprising a transaction amount for the electronic commerce transaction; (2) generate a unique identifier for the electronic commerce transaction; (3) create a payment notice comprising the unique identifier and the transaction amount for the electronic commerce transaction; and (4) transmit at least one automated reminder message to a purchaser associated with the electronic commerce transaction if the transaction amount is not paid; and
a database server operable to store the transaction amount in relation to the unique identifier for the electronic commerce transaction.

40. The system of claim 39, wherein the payment notice request is received from a requester selected from the following group: an electronic commerce merchant and an electronic commerce aggregator.

41. The system of claim 40, wherein the application server is operable to transmit the payment notice to the requester.

42. The system of claim 40, wherein the application server is operable to transmit the payment notice to the purchaser associated with the electronic commerce transaction.

43. The system of claim 39, wherein the application server is operable to determine a payment notice expiration date, and wherein the database server is operable to store the payment notice expiration date in relation to the unique identifier for the electronic commerce transaction.

44. The system of claim 43, wherein the application server is operable to calculate the payment notice expiration date.

45. The system of claim 44, wherein the payment notice expiration date comprises a payment notice creation date plus a specified period of time.

46. The system of claim 39, wherein the automated reminder message comprises one or more of the following: a voice message, a text message, an e-mail, and an instant message.

47. The system of claim 43, wherein the automated reminder message comprises a textual or audio alert notifying the purchaser of the payment notice expiration date.

48. The system of claim 43, wherein a plurality of automated reminder messages are transmitted to the purchaser until the earlier of (i) a date on which the transaction amount is paid or (ii) the payment notice expiration date.

49. The system of claim 39, wherein the application server is operable to receive a payment notice validation request from a retailer.

50. The system of claim 49, wherein the payment notice validation request comprises a payment amount and the unique identifier for the electronic commerce transaction.

51. The system of claim 50, wherein the payment amount is equal to the transaction amount, and wherein the database server is operable to store an indication that the transaction amount is paid.

52. A computer-implemented method for notifying a purchaser of an unpaid payment notice associated with an electronic commerce transaction, comprising:
receiving a payment notice request comprising a transaction amount for the electronic commerce transaction;
generating a unique identifier for the electronic commerce transaction;
creating a payment notice comprising the unique identifier and the transaction amount for the electronic commerce transaction;
transmitting at least one automated reminder message to a purchaser associated with the electronic commerce transaction if the transaction amount is not paid; and
storing the transaction amount in relation to the unique identifier for the electronic commerce transaction.

53. The computer-implemented method of claim 52, wherein the payment notice request is received from a requester selected from the following group: an electronic commerce merchant and an electronic commerce aggregator.

54. The computer-implemented method of claim 53, further comprising transmitting the payment notice to the requester.

55. The computer-implemented method of claim 53, further comprising transmitting the payment notice to the purchaser associated with the electronic commerce transaction.

56. The computer-implemented method of claim 52, further comprising determining a payment notice expiration date and storing the payment notice expiration date in relation to the unique identifier for the electronic commerce transaction.

57. The computer-implemented method of claim 56, further comprising calculating the payment notice expiration date.

58. The computer-implemented method of claim 57, wherein the payment notice expiration date comprises a payment notice creation date plus a specified period of time.

59. The computer-implemented method of claim 52, wherein the automated reminder message comprises one or more of the following: a voice message, a text message, an e-mail, and an instant message.

60. The computer-implemented method of claim 56, wherein the automated reminder message comprises a textual or audio alert notifying the purchaser of the payment notice expiration date.

61. The computer-implemented method of claim 56, wherein a plurality of automated reminder messages are transmitted to the purchaser until the earlier of (i) a date on which the transaction amount is paid or (ii) the payment notice expiration date.

62. The computer-implemented method of claim 52, further comprising receiving a payment notice validation request from a retailer.

63. The computer-implemented method of claim 62, wherein the payment notice validation request comprises a payment amount and the unique identifier for the electronic commerce transaction.

64. The computer-implemented method of claim 63, wherein the payment amount is equal to the transaction amount, and wherein the method further comprises storing an indication that the transaction amount is paid.

65. A system for creating a payment notice associated with an electronic commerce transaction, comprising:
an application server operable to: (1) receive a payment notice request comprising a first transaction amount in a first currency for the electronic commerce transaction; (2) generate a unique identifier for the electronic commerce transaction; (3) convert the first transaction amount in the first currency to a second transaction amount in a second currency; (4) create a payment notice comprising the unique identifier and the second transaction amount in the second currency for the electronic commerce transaction; and
a database server operable to store the first transaction amount in the first currency and the second transaction amount in the second currency in relation to the unique identifier for the electronic commerce transaction.

66. The system of claim 65, wherein the second transaction amount in the second currency comprises the first transaction amount in the first currency multiplied by a conversion rate.

67. The system of claim 66, wherein the payment notice also comprises the first transaction amount in the first currency and the conversion rate.

68. The system of claim 65, wherein the payment notice request is received from a requester selected from the following group: an electronic commerce merchant and an electronic commerce aggregator.

69. The system of claim 68, wherein the application server is operable to transmit the payment notice to the requester.

70. The system of claim 68, wherein the application server is operable to transmit the payment notice to a purchaser associated with the electronic commerce transaction.

71. The system of claim 65, wherein the application server is operable to receive a payment notice validation request from a retailer.

72. The system of claim 71, wherein the payment notice validation request comprises the unique identifier presented on the payment notice.

73. The system of claim 72, wherein the payment notice validation request comprises a payment amount in the second currency and the unique identifier for the electronic commerce transaction.

74. The system of claim 73, wherein the payment amount is equal to the second transaction amount, and wherein the database server is operable to store an indication that the second transaction amount is paid.

75. A computer-implemented method for creating a payment notice associated with an electronic commerce transaction, comprising:
receiving a payment notice request comprising a first transaction amount in a first currency for the electronic commerce transaction;
generating a unique identifier for the electronic commerce transaction;
converting the first transaction amount in the first currency to a second transaction amount in a second currency;
creating a payment notice comprising the unique identifier and the second transaction amount in the second currency for the electronic commerce transaction; and
storing the first, transaction amount in the first currency and the second transaction amount in the second currency in relation to the unique identifier for the electronic commerce transaction.

76. The computer-implemented method of claim 75, wherein the second transaction amount in the second currency comprises the first transaction amount in the first currency multiplied by a conversion rate.

77. The computer-implemented method of claim 76, wherein the payment notice also comprises the first transaction amount in the first currency and the conversion rate.

78. The computer-implemented method of claim 75, wherein the payment notice request is received from a requester selected from the following group: an electronic commerce merchant and an electronic commerce aggregator.

79. The computer-implemented method of claim 78, further comprising transmitting the payment notice to the requester.

80. The computer-implemented method of claim 78, further comprising transmitting the payment notice to a purchaser associated with the electronic commerce transaction.

81. The computer-implemented method of claim 75, further comprising receiving a payment notice validation request from a retailer.

82. The computer-implemented method of claim 81, wherein the payment notice validation request comprises the unique identifier presented on the payment notice.

83. The computer-implemented method of claim 82, wherein the payment notice validation request comprises a payment amount in the second currency and the unique identifier for the electronic commerce transaction.

84. The computer-implemented method of claim 83, wherein the payment amount is equal to the second transaction amount, and wherein the method further comprises storing an indication that the second transaction amount is paid.
